(19) United States
(12) Patent Application Publication
(10) Pub. No.: US 2025/0385628 A1
(43) Pub. Date: Dec. 18, 2025

(54) POWER CONVERSION DEVICE

(71) Applicant: Mitsubishi Electric Corporation, Tokyo (JP)

(72) Inventor: Shuta ISHIKAWA, Tokyo (JP)

(73) Assignee: Mitsubishi Electric Corporation, Tokyo (JP)

(21) Appl. No.: 18/879,820

(22) PCT Filed: Aug. 8, 2022
(86) PCT No.: PCT/JP2022/030234

§ 371 Date: Dec. 30, 2024

(51) Int. Cl. H02P 21/14; H02P 21/22; H02P 27/06

(52) U.S. Cl. CPC H02P 21/14; H02P 21/22; H02P 27/06

(57) ABSTRACT

A power conversion device includes a rectifier which converts three-phase AC voltages to DC voltage, a power converter which converts the DC voltage to AC voltage, to control an electric motor, and a controlling circuitry. The controlling circuitry derives, as a pulsation voltage prediction value, pulsation contained in DC voltage obtained through full-wave rectification of the three-phase AC voltages, using a detected value of the three-phase AC voltages, and derives pulsation contained in the DC voltage, as a pulsation voltage actual measured value, using a detected value of the DC voltage. The controlling circuitry corrects at least one of a D-axis voltage command or a Q-axis voltage command by a voltage correction command generated so as to reduce a deviation between the pulsation voltage prediction value and the pulsation voltage actual measured value.

### TECHNICAL FIELD

The present disclosure relates to a power conversion device.

### BACKGROUND ART

As a power conversion device for driving an AC motor, there is known a power conversion device that includes a rectifier which rectifies AC power inputted from a three-phase AC power supply such as a commercial power supply to DC power, and an inverter which converts the DC power to AC power suitable for an AC motor and outputs the AC power to the AG motor. In general, it is known that, when three-phase AC voltages are rectified by a rectifier composed of diodes, pulsation having a frequency that is six times the frequency of an AC power supply occurs in the rectified DC voltage.

Here, a smoothing capacitor is provided in a DC link section connecting the DC output side of the rectifier and the DC input side of the inverter. An inductance component on the AC power supply and the smoothing capacitor form an IC resonance circuit. If the resonant frequency of the LC resonance circuit coincides with the frequency that is six times the power supply frequency, DC voltage at the DC link section greatly pulsates. In particular, in a case where a small-capacity film capacitor is used as the smoothing capacitor for the purpose of device size reduction or the like, great pulsation of DC voltage and distortion of power supply current are likely to occur, so that it might become difficult to continuously operate the power conversion device. For solving this problem, an inverter device having the following configuration as a power conversion device is disclosed.

That is, the conventional inverter device includes an inductor connected between a diode bridge as a rectifier and an inverter unit, and a capacitor connected to an input terminal of the inverter unit. A control unit for the inverter unit multiplies voltage across the inductor detected by a voltage detector by a gain (k). The voltage across the inductor multiplied by the gain (k) is subtracted from an initial value of a voltage control ratio or a signal from a PI controller (see, for example, Patent Document 1).

### CITATION LIST

### Patent Document

Patent Document 1: Japanese Laid-Open Patent Publication No. 2008-29151 (FIG. 18 and FIG. 13)

### SUMMARY OF THE INVENTION

### Problem to be Solved by the Invention

In the conventional inverter device described above, after the voltage across the inductor provided between the diode bridge and the smoothing capacitor is detected and multiplied by the gain (k), a current command which is a signal from the PI controller or a modulation factor which is a voltage control ratio is corrected. Thus, pulsation of power supply current and DC voltage can be reduced.

However, in such a correction method based on a detected value of the voltage across the inductor, the effect of control for suppressing pulsation becomes smaller in a condition in which the impedance on the power supply side is greater. In addition, in a case of correcting the current command, it is difficult to reduce pulsation unless a current control system is designed to have extremely high response. Further, on the DC Link voltage, high-order pulsation that is due to rectification operation of the rectifier, resonance of the LC resonance circuit, and the like and is higher than sixth order, for example, is superimposed, in addition to pulsation having a frequency that is six times the power supply frequency. The conventional correction method has a problem that the effect of suppressing such pulsation is small and the effect of suppressing distortion of power supply current is also small.

The present disclosure has been made to solve the above problem, and an object of the present disclosure is to provide a power conversion device that can effectively suppress pulsation occurring in power supply current and a DC link section.

### Means to Solve the Problem

A power conversion device according to the present disclosure includes: a rectification unit which converts inputted three-phase AC voltages to DC voltage and outputs the DC voltage to a DC bus; a power converter which converts the DC voltage on the DC bus converted by the rectification unit, to AC voltage, to control an electric motor; and a control unit which controls the power converter. The control unit converts current flowing through the electric motor to D-axis current and Q-axis current in an orthogonal two-axis coordinate system, generates a D-axis voltage command so that the D-axis current follows a D-axis current command, generates a Q-axis voltage command so that the Q-axis current follows a Q-axis current command, and controls the power converter on the basis of the generated D-axis voltage command and the generated Q-axis voltage command. The control unit derives, as a pulsation voltage prediction value, pulsation contained in the DC voltage obtained through full-wave rectification of the three-phase AC voltages, on the basis of a detected value of the three-phase AC voltages, and derives pulsation contained in the DC voltage, as a pulsation voltage actual measured value, on the basis of a detected value of the DC voltage. The control unit corrects at least one of the D-axis voltage command or the Q-axis voltage command by a voltage correction command generated so as to reduce a deviation between the pulsation voltage prediction value and the pulsation voltage actual measured value.

### EFFECT OF THE INVENTION

With the power conversion device according to the present disclosure, it is possible to effectively suppress pulsation occurring in power supply current and the DC link section.

### BRIEF DESCRIPTION OF THE DRAWINGS

FIG. 1 is block diagram showing a schematic configuration of a power conversion device according to embodiment 1.

FIG. 2 is a control block diagram showing an internal configuration of a control unit of the power conversion device according to embodiment 1.

FIG. 3 is a control block diagram showing a configuration of a pulsation suppression control unit of the power conversion device according to embodiment 1.

FIG. 4 shows an example of a hardware configuration of the control unit as a control device according to embodiment 1.

FIG. 5A and FIG. SB show operation waveforms in a power conversion device of a comparative example.

FIG. 6A and FIG. 6B show operation: waveforms in the power conversion device according to embodiment 1.

FIG. 7A and FIG. 78 show operation waveforms in the power conversion device according to embodiment 1.

FIG. 8 is a control block diagram showing an internal configuration of a pulsation suppression control unit of a power conversion device according to embodiment 2.

FIG. 9 is a control block diagram showing an internal configuration of a pulsation suppression control unit of the power conversion device according to embodiment

### DESCRIPTION OF EMBODIMENTS

### Embodiment 1

A power conversion device 100 according to the present embodiment 1 will be described with reference to the drawings.

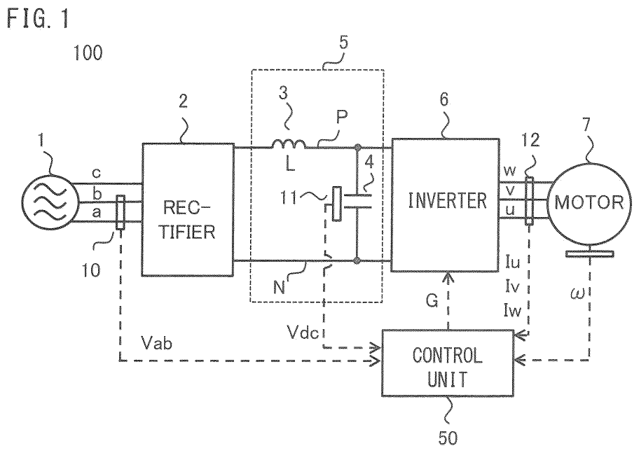

FIG. 1 is a block diagram showing the schematic configuration of the power conversion device 100 according to embodiment 1.

The power conversion device 100 is provided between a three-phase AC power supply 1 such as a commercial power supply and a motor 7 as an electric motor. The power conversion device 100 converts AC power from the AC power supply 1 to DC power once, converts the converted DC power to AC power, and supplies the AC power to the motor 7 as a load. The power conversion device 100 includes a rectifier 2 as a rectification unit, a DC link section 5, an inverter 6 as a power converter, and a control unit 50.

The rectifier 2 is composed of diodes and converts three-phase AC voltages inputted from the three-phase AC power supply 1, to DC voltage, through full-wave rectification.

The DC link section 5 is provided between the rectifier 2 and the inverter 6, and supplies DC power converted by the rectifier 2, to the inverter 6. The DC link section 5 includes positive and negative DC buses P, N connecting the DC output side of the rectifier 2 and the DC input side of the inverter 6, a DC reactor 3 connected in series on the positive DC bus P, and a smoothing capacitor 4 provided between the positive and negative DC buses P, N.

The inverter 6 includes six semiconductor elements (not shown). While the semiconductor elements are driven by drive signals G from the control unit 50, the inverter 6 converts DC voltage from the DC link section 5 to AC voltage with variable voltage and a variable frequency, thus controlling the motor 7 at an arbitrary rotational speed.

The power conversion device 100 further includes a voltage sensor 10 for detecting line voltage Vab of the AC voltages on the AC power supply 1, a voltage sensor 11 for detecting DC bus voltage Vdc between the DC buses P, N, and a load current sensor 12 for detecting load currents Iu, Iv, Iw flowing in the respective phases of the motor 7.

As inputs to the control unit 50, information about the DC bus voltage Vdc, information about the load currents Iu, Iv, Iw flowing through the motor 7, and information about an angular velocity w of the motor 7, are inputted, and in addition, there is a feature that information about the line voltage Vab on the AC power supply 1 side detected by the voltage sensor 10, which is used for suppressing pulsation occurring in the AC power supply 1 and the DC link section 5, is further inputted, as described later in detail. The control unit 50 generates the drive signals G for controlling the inverter 6, on the basis of the inputted detected values.

It has been described that the load current sensor 12 acquires all the load currents Iu, Iv, Iw for three phases. However, if currents for two phases among the three phases are detected, current for the other one phase can be calculated. Therefore, currents to be actually detected may be for only two phases. As another method, a current sensor may be provided on the input negative side of semiconductor elements of the inverter 6 and sampling is performed a plurality of times, whereby each of three-phase currents can be calculated.

It is general that the DC reactor 3 is interposed on the DC bus 8, for reducing harmonic noise. However, in the power conversion device 100 of the present embodiment, it is not always necessary to use the DC reactor 3, and therefore the DC reactor 3 may be omitted.

Next, the control unit 50 will be described.

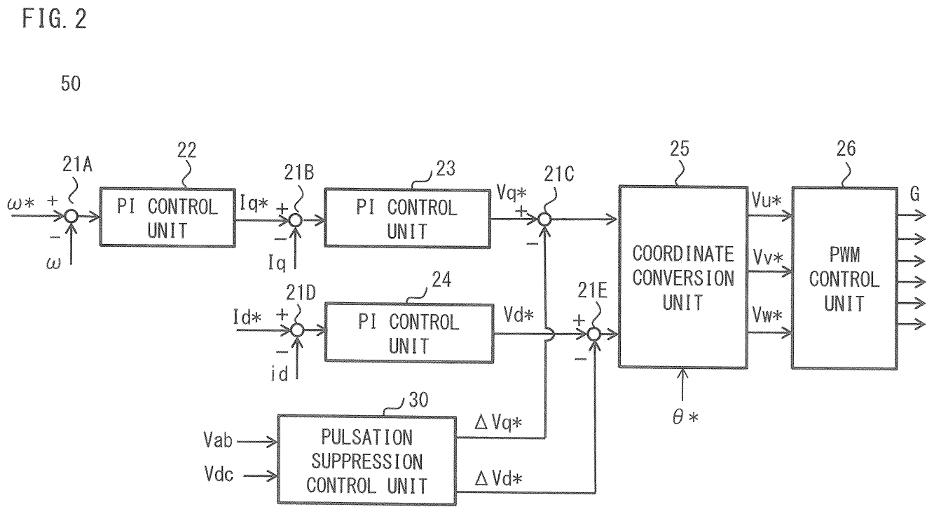

FIG. 2 is a control block diagram showing an internal configuration of the control unit 50 of the power conversion device 100 according to embodiment 1. In the present embodiment, a control block for performing vector control is adopted.

The control unit 50 includes PI control units 22, 23, 24 which perform feedback control on the basis of inputted deviations, a coordinate conversion unit 25 which converts a D-axis voltage command Vd* and a Q-axis voltage command Vg* for two phases to voltage commands Vu*, Vv*, Vw* for three phases, a PWM control unit 26 which generates the drive signals G for driving the semiconductor elements of the inverter 6 on the basis of the converted voltage commands Vu*, Vv*, Vw*, a pulsation suppression control unit 30 which performs control for suppressing pulsation in the power supply current and the DC link section 5, and subtractors 21A, 218, 21C, 210, 21E.

In the control unit 50, the detected load currents Iu, Iv, Iw of the motor 7 are converted to D-axis current Id and Q-axis current Ig in an orthogonal two-axis coordinate system by a converter (not shown)

The subtractor 21A calculates a deviation between an angular velocity command ω* which is a speed command and the angular velocity ω estimated through position-sensorless control, and the PI control unit 22 performs PI control so that the calculated deviation becomes small, thereby deriving a Q-axis current command Iq*.

The subtractor 218 calculates a deviation between the Q-axis current command Iq* and the detected Q-axis current Iq, and the PI control unit 23 performs PI control so that the calculated deviation becomes small, i.e., the Q-axis current Iq follows the Q-axis current command Iq*, thereby calculating the Q-axis voltage command Vq*,

Similarly for D axis, the subtractor 21D calculates a deviation between a D-axis current command Id* and the detected D-axis current Id, and the PI control unit 24 performs PI control so that the calculated deviation becomes small, i.e., the D-axis current Id follows the D-axis current command Id*, thereby calculating the D-axis voltage command Vd*.

The pulsation suppression control unit 30 calculates a D-axis voltage correction command ΔVd* as a voltage correction command and a Q-axis voltage correction command ΔVq* as a voltage correction command. The pulsation suppression control unit 30 will be described later in detail.

Then, the subtractor 21E subtracts the D-axis voltage correction command ΔVd* from the D-axis voltage command Vd*, to correct the D-axis voltage command Vd*. In addition, the subtractor 21C subtracts the Q-axis voltage correction command ΔVq* from the Q-axis voltage command Vq* to correct the Q-axis voltage command Vq*. The corrected D-axis voltage command Vd* and Q-axis voltage command Vg* are inputted to the coordinate conversion unit 25.

The coordinate conversion unit 25 performs coordinate conversion from a D, Q-axis rotating coordinate system to a U, V, W coordinate system at rest corresponding to actual output voltage commands. The voltage commands Vu*, Vv*, Vw* for the respective phases obtained through the coordinate conversion are inputted to the PWM control unit 26.

The PWM control unit 26 generates the drive signals G for the semiconductor elements of the inverter 6, on the basis of the inputted voltage commands Vu*, Vv*, Vw* for the respective phases.

The coordinate conversion unit 25 and the PWM control unit 26 are means used in general inverter control, and therefore the detailed description thereof is omitted here.

In the control block described here, DO-axis decoupling control for inhibiting coupling of D and ω axes is not described, but DO-axis decoupling control may be performed before voltage command correction is performed by the D-axis voltage correction command ΔVd* and the Q-axis voltage correction command ΔVq* from the pulsation suppression control unit 30.

Next, the details of the pulsation suppression control unit 30 which is a major part of the power conversion device 100 of the present embodiment will be described.

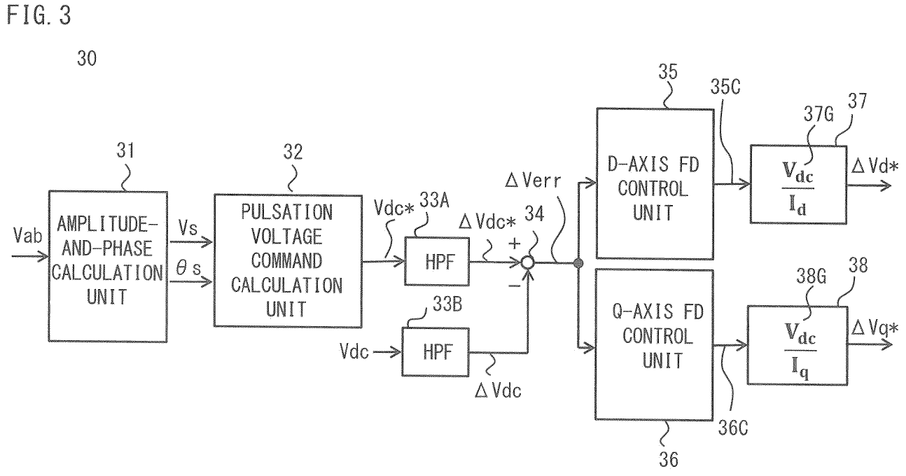

FIG. 3 is a control block diagram showing a configuration of the pulsation suppression control unit 30 of the power conversion device 100 according to embodiment 1.

The pulsation suppression control unit 30 performs pulsation suppression control for suppressing voltage pulsation and current distortion occurring from the AC power supply 1 to the DC link section 5.

The pulsation suppression control unit 30 includes an amplitude-and-phase calculation unit 31, a pulsation voltage command calculation unit 32, a D-axis feedback control unit 35 and a Q-axis feedback control unit 36 which perform feedback control on the basis of inputted deviations, gain adjustment units 37, 38, and high-pass filters 33A, 33B.

The pulsation suppression control unit 30 receives two inputs, i.e., the detected line voltage Vab on the AC power supply 1 side and the detected DC bus voltage Vdc. Then, the pulsation suppression control unit 30 outputs two values, i.e., the D-axis voltage correction command ΔVd* and the Q-axis voltage correction command ΔVq*.

Hereinafter, pulsation suppression control performed by the pulsation suppression control unit 30 will be described sequentially from an input of the line voltage Vab.

First, the amplitude-and-phase calculation unit 31 calculates an amplitude Vs and a phase es from an analog voltage signal. As a calculation method, a method called enhanced phase locked loop (ePLL) can be used. The amplitude Vs and the phase θs of AC voltage may be derived using a zero-cross signal of the line voltage Vab. In a case of detecting only a zero-cross point from negative to positive, a zero-cross signal is inputted once per power supply cycle. Using a time T1 between zero-cross points and a time T2 between zero-cross points in the previous cycle, a phase angle can be calculated as shown by the following Formula (1). The unit thereof is radian [rad].

$$[ Mathematical 1 ]$$

$$θ = T 1 / T 2 * 2 π \qquad ( 1 )$$

The magnitude of the amplitude Vs can be calculated by integrating the absolute value of the power supply line voltage Vab between zero-cross points and then taking an average value thereof, as shown by the following Formula (2).

$$[ Mathematical 2 ]$$

$${V}_{s} = \frac{π}{2} \frac{1}{T 1} {\int }_{0}^{T 1} \vert {V}_{ab} \vert dt \qquad ( 2 )$$

In Formula (2), n/2 is a coefficient for converting an average value to an effective value. As described above, the amplitude Vs and the phase θs can be derived from the zero-cross signal using the above formulae (1) and (2).

Without detecting the line voltage Vab in an analog manner, it is possible to calculate the amplitude Vs and the phase θs by only a zero-cross signal. In this case, the amplitude Vs can be derived by the following Formula (3) using an average value Vdcave of the DC bus voltage.

$$[ Mathematical 3 ]$$

$${V}_{s} = {K}_{1} {V}_{dcave} \qquad ( 3 )$$

Here, K1 is a gain, and normally, K1 is set at n/3. In a case where a resistance component such as a power supply impedance is great, K1 may be slightly adjusted to be a little greater,

The amplitude Vs and the phase es of AC voltage calculated by the amplitude-and-phase calculation unit 31 are inputted to the pulsation voltage command calculation unit 32.

The pulsation voltage command calculation unit 32 can reproduce phase voltages Va, Vb, Vc of the three-phase AC power supply 1, using the inputted amplitude Vs and phase θs, as shown by the following Formulae (4) to (6).

$$[ Mathematical 4 ]$$

$${V}_{a} = {V}_{s} / \sqrt{6} \cdot sin ( θ - π / 6 ) \qquad ( 4 )$$

$$[ Mathematical 5 ]$$

$${V}_{b} = {V}_{s} / \sqrt{6} \cdot sin ( θ + 3 π / 6 ) \qquad ( 5 )$$

$$[ Mathematical 6 ]$$

$${V}_{c} = {V}_{s} / \sqrt{6} \cdot sin ( θ - 5 π / 6 ) \qquad ( 6 )$$

Then, regarding the reproduced phase voltages Va, Vb, Vc of the three-phase AC power supply 1, for every phase, the smallest phase voltage Va, Vb, Ve is subtracted from the greatest phase voltage Va, Vb, Vc at each phase, whereby a DC bus voltage prediction value Vdc* can be derived. This is expressed by Formula (7).

$$\begin{matrix}[ Mathematical 7 ] & \\ {V}_{dc}^{*} = MAX ( {V}_{a} , {V}_{b} , {V}_{c} ] - MIN [ {V}_{a} , {V}_{b} , {V}_{c} ] & ( 7 )\end{matrix}$$

Then, a DC component of the DC bus voltage prediction value Vdc* is removed by the high-pass filter 33A, whereby a pulsation voltage prediction value ΔVdc* extracted as an AC component can be calculated.

The pulsation voltage prediction value ΔVdc* is a prediction value of an AC component contained in the DC bus voltage between the DC buses P. N obtained through full-wave rectification of the three-phase AC voltages, and is pulsation that oscillates at a frequency that is six times the frequency of AC voltage of the AC power supply 1.

Next, description will be given sequentially from the DC bus voltage Vdc inputted on the lower side in FIG. 3.

The DC bus voltage Vdc detected by the voltage sensor 11 passes through the high-pass filter 33B in which a DC component is removed, and thus the pulsation voltage actual measured value ΔVdc extracted as an actual AC component on the DC buses P, N is derived.

The reason why the high-pass filters 33A, 33B are provided is that, if DC components are contained in the pulsation voltage prediction value ΔVdc* and the pulsation voltage actual measured value ΔVdc that are derived, they interfere with current control shown in FIG. 2, so that motor control might not work appropriately. Therefore, it is necessary to interpose the high-pass filters 33A, 33B.

Then, the subtractor 34 subtracts the pulsation voltage actual measured value ΔVdc from the pulsation voltage prediction value ΔVdc*, to calculate a deviation ΔVerr.

Here, the pulsation voltage actual measured value ΔVdc which is the actual measured value of actual pulsation in the DC link section 5 has a higher crest value than the pulsation voltage prediction value ΔVdc* which is predicted through calculation and oscillates at a frequency that is six times the power supply frequency. Further, the pulsation voltage actual measured value ΔVdc has a waveform also containing high-order pulsation that has a frequency higher than six times the power supply frequency and is due to actual rectification operation of the rectifier 2, resonance of the LC resonance circuit formed in the actual circuit, and the like. Therefore, the deviation ΔVerr derived by subtracting the pulsation voltage actual measured value ΔVdc from the pulsation voltage prediction value ΔVdc* has a waveform containing sixth-order pulsation and high-order pulsation for higher than sixth order.

Then, so as to reduce the deviation ΔVerr, i.e., reduce pulsation containing sixth-order pulsation and high-order pulsation for higher than sixth order, on D axis, the D-axis feedback control unit 35 performs feedback control to derive a controlled variable 35C.

Then, the gain adjustment unit 37 multiplies the controlled variable 35C by a gain 37G (Vdc/Id) as a first gain which is proportional to the DC bus voltage Vdc and inversely proportional to the D-axis current Id, to calculate the D-axis voltage correction command ΔVd*.

As the feedback control, normally, proportional (P) control is used. In a case where a control band is raised, proportional differential (PD) control may be used.

The P control can be represented by the following Formula (8), and the PD control can be represented by the following Formula (9),

$$\begin{matrix}[ Mathematical 8 ] & \\ G ( s ) = {K}_{P} & ( 8 )\end{matrix}$$

$$\begin{matrix}[ Mathematical 9 ] & \\ G ( s ) = {K}_{P} + {K}_{d} s & ( 9 )\end{matrix}$$

In the above Formula (8) and Formula (9), Kp is a proportional gain as a control gain, and Kd is a differential gain as a control gain. Instead of performing PD control, P control and phase-lead control using a phase-lead compensation filter may be performed. The phase-lead control is control for advancing a phase of the controlled variable derived through P control by a set phase amount, so as to compensate for control lag that occurs depending on the control cycle for performing feedback control, whereby the effect of pulsation suppression can be improved,

Similarly for Q axis, so as to reduce the deviation ΔVerr, i.e., reduce pulsation containing sixth-order pulsation and high-order pulsation for higher than sixth order, the feedback control unit 36 performs feedback control to calculate a controlled variable 36C.

Then, the gain adjustment unit 38 multiplies the controlled variable 36C by a gain 38G (Vdc/Ig) as a first gain which is proportional to the DC bus voltage Vdc and inversely proportional to the Q-axis current Iq, to calculate the Q-axis voltage correction command ΔVq*.

In a case where the DC bus voltage Vdc has increased, the D-axis voltage correction command ΔVd* and the Q-axis voltage correction command ΔVq* as described above are to perform correction so that d-axis voltage and q-axis voltage increase, in order to increase output power of the inverter 6. In a case where the DC bus voltage Vdc has decreased, the D-axis voltage correction command ΔVd* and the Q-axis voltage correction command ΔVq* are to perform correction so that d-axis voltage and q-axis voltage decrease, in order to decrease the output power of the inverter 6. In this way, pulsation suppression control for suppressing pulsation in power supply current and the DC link section 5 is performed.

The magnitudes of the controlled variables 35C, 36C in the present embodiment are adjusted by the gains 37G, 38G as first gains.

The gains 37G, 38G provide an effect of making the control effect of the pulsation suppression control constant. Hereinafter, description will be given using the gain 37G as an example.

First, output power of the inverter 6 is defined as Pout+ΔPout, A DC component of the output power is Pout, and pulsation power of the output power is ΔPout. Pout means DC power that is generated through normal motor control, and ΔPout means pulsation power generated for suppressing resonance. The output power Pout+ΔPout can be calculated by the following Formula (10).

$$\begin{matrix}[ Mathematical 10 ] & \\ {P}_{out} + Δ {P}_{out} = ( {V}_{d} + Δ {V}_{d} ) ( {I}_{d} + Δ {I}_{d} ) + ( {V}_{q} + Δ {V}_{q} ) ( {I}_{q} + Δ {I}_{q} ) = ( {V}_{d} {I}_{d} + {V}_{d} Δ {I}_{d} + Δ {V}_{d} {I}_{d} + Δ {V}_{d} Δ {I}_{d} ) + ( {V}_{q} {I}_{q} + {V}_{q} Δ {I}_{q} + Δ {V}_{q} {I}_{q} + Δ {V}_{q} Δ {I}_{q} ) & ( 10 )\end{matrix}$$

Here, Vd is a DC component of D-axis voltage, ΔVd is an AC component of D-axis voltage, Vq is a DC component of Q-axis voltage, ΔVq is an AC component of Q-axis voltage, Id is a DC component of D-axis current, ΔId is an AC component of D-axis current, Iq is a DC component of Q-axis current, and ΔIq is an AC component of Q-axis current.

The DC component power Pout is represented by Formula (11),

$$\begin{matrix}[ Mathematical 11 ] & \\ {P}_{out} = {V}_{d} {I}_{d} + {V}_{q} {I}_{q} & ( 11 )\end{matrix}$$

Then, ΔPout can be derived from Formulae (10) and (11) and is represented by Formula (12).

$$\begin{matrix}[ Mathematical 12 ] & \\ Δ {P}_{out} = ( {V}_{d} Δ {I}_{d} + Δ {V}_{d} {I}_{d} + Δ {V}_{d} Δ {I}_{d} ) + ( {V}_{q} Δ {I}_{q} + Δ {V}_{q} {I}_{q} + Δ {V}_{q} Δ {I}_{q} ) & ( 12 )\end{matrix}$$

In the above Formula (12), a term of ΔV*I which is a product of the voltage AC component ΔV and the current DC component T is dominant. According to the characteristics of the motor, ΔI does not greatly change even when ΔV changes, Therefore, a term of AI can be neglected, to obtain approximation. By the approximation, Formula (13) is obtained.

$$\begin{matrix}[ Mathematical 13 ] & \\ Δ {P}_{out} \approx Δ {V}_{d} {I}_{d} + Δ {V}_{q} {I}_{q} & ( 13 )\end{matrix}$$

Next, input current to the inverter 6 is to be calculated. Input power to the inverter 6 is defined as Pin +ΔPin and can be represented by the following Formula (14).

$$\begin{matrix}[ Mathematical 14 ] & \\ {P}_{in} + Δ {P}_{in} = ( {V}_{dc} + Δ {V}_{dc} ) ( {I}_{dc} + Δ {I}_{dc} ) = ( {V}_{dc} {I}_{dc} + {V}_{dc} Δ {I}_{dc} + {ΔV}_{dc} {I}_{dc} + Δ {V}_{dc} Δ {I}_{dc} ) & ( 14 )\end{matrix}$$

Here, Vdc is a DC voltage component of DC bus voltage, ΔVdc is an AC component of DC bus voltage, Idc is a DC component of Inverter input current, and ΔIdc is an AC component of inverter input current.

The DC component power Pin is represented by the following Formula (15).

$$\begin{matrix}[ Mathematical 15 ] & \\ {P}_{in} = {V}_{dc} {I}_{dc} & ( 15 )\end{matrix}$$

Then, ΔPin can be derived from Formulae (14) and (15) and is represented by the following Formula (16).

$$\begin{matrix}[ Mathematical 16 ] & \\ Δ {P}_{in} = {V}_{dc} Δ {I}_{dc} + Δ {V}_{dc} {I}_{dc} + Δ {V}_{dc} Δ {I}_{dc} & ( 16 )\end{matrix}$$

Here, as long as control is appropriately performed on the inverter 6, a term of ΔVdc which is an oscillation component of bus voltage becomes small, and a term of Vdc ΔIdc is dominant. Thus, by approximation, the following Formula (17) is obtained.

$$\begin{matrix}[ Mathematical 17 ] & \\ Δ {P}_{in} \approx {V}_{dc} Δ {I}_{dc} & ( 17 )\end{matrix}$$

By transferring Aldo to the left-hand side and arranging the expression, Formula (18) is obtained.

$$\begin{matrix}[ Mathematical 18 ] & \\ Δ {I}_{dc} \approx Δ {P}_{in} / {V}_{dc} & ( 18 )\end{matrix}$$

Since ΔPin and ΔPout become equal to each other, Formula (13) is substituted into Δpin is Formula (18), whereby Formula (19) can be derived.

$$\begin{matrix}[ Mathematical 19 ] & \\ Δ {I}_{dc} = {I}_{d} / {V}_{dc} \cdot Δ {V}_{d} + {I}_{q} / {V}_{dc} \cdot Δ {V}_{q} & ( 19 )\end{matrix}$$

From a result of Formula (19), it is found that, if the pulsation voltage ΔVd is intentionally given to D axis in order to suppress resonance, the input current ΔIdo having pulsation whose magnitude is proportional to the b-axis current Id and inversely proportional to the DC bus voltage Vdc can be obtained with respect to the given pulsation voltage ΔVd. Accordingly, it is found that, if Id or vdc changes, a controlled variable of Aldo also changes.

Therefore, in order to make ΔIdc constant, for D axis, using the gain 37G, the controlled variable 35C for giving pulsation voltage to the D-axis voltage command Vd* is multiplied by the gain 37G so as to be proportional to the DC bus voltage Vdc and inversely proportional to the D-axis current Id. Similarly for Q axis, using the gain 38G, the controlled variable 36C for giving pulsation voltage to the Q-axis voltage command Vq* is multiplied by the gain 38G so as to be proportional to the DC bus voltage Vdc and inversely proportional to the Q-axis current Iq.

The values of the DC bus voltage Vdc, the D-axis current Id, and the Q-axis current Iq used in the gains 37G, 38G may be average values during driving of the motor 7, but are not limited thereto. For example, the values of the gains 37G, 38G may be updated in accordance with detected values of the DC bus voltage Vdc, the D-axis current Id, and the Q-axis current Iq during driving of the motor 7, instead of using predetermined fixed valves.

The gain 37G adjusts the controlled variable of feedback control proportionally to the detected DC bus voltage Vdc and inversely proportionally to the detected D-axis current Id. By performing such adjustment of the controlled variable, even if Vdc or Id changes, the controlled variable of ΔIdc can be made constant, and the effect of control can be further kept constant. Thus, variations in the control effect such as deficiency of the controlled variable and occurrence of pulsation depending on the condition can be suppressed, whereby resonance can be suppressed more efficiently,

It has been described that the gain 37G is configured to be inversely proportional to the D-axis current Id and the gain 38G is configured to be inversely proportional to the Q-axis current Ig. However, the configurations are not limited thereto. As shown by the above Formula (19), as long as the gains 370, 38G are both at least configured to be proportional to the DC bus voltage Vdc, an effect of making ΔIdc constant is obtained to a certain extent, even if the gains 37G, 38G are not configured to be inversely proportional to the D-axis current Id and the Q-axis current Iq.

It is also possible that only one of the D-axis voltage command Vd* and the Q-axis voltage command Vq* is corrected by a voltage correction command. In this case, if the D-axis voltage command Vd* need not be corrected, control may be performed so as to disable the D-axis voltage correction command ΔVd*.

Alternatively, in such a case where flux weakening control or the like is performed, if operation is performed so as to apply current also to d axis in addition to q axis, both of the D-axis voltage command Vd* and the Q-axis voltage command Vq* may be corrected by voltage correction commands. Thus, even in a case where the motor 7 rotates at a high speed, resonance can be suppressed, and sound operation of the motor 7 can be ensured over a wide speed range,

Hereinafter, a configuration of hardware of the control unit 50 will be described.

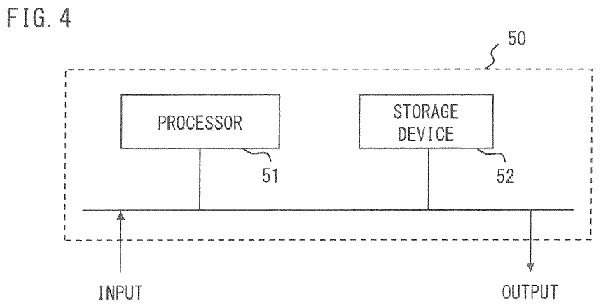

As described below with reference to FIG. 4, the control unit 50 is generally formed by means such as a microcomputer which executes the control blocks shown in FIG. 2 and FIG. 3.

FIG. 4 shows an example of a hardware configuration of the control unit 50 as a control device according to embodiment 1.

As shown in the hardware example in FIG. 3, the control device is composed of a processor 51 and a storage device 52. The storage device 52 is provided with a volatile storage device such as a random access memory and a nonvolatile auxiliary storage device such as a flash memory, although not shown.

Instead of the flash memory, an auxiliary storage device of a hard disk may be provided. The processor 51 executes a program inputted from the storage device 52. In this case, the program is inputted from the auxiliary storage device to the processor 51 via the volatile storage device. The processor 51 may output data such as a calculation result to the volatile storage device of the storage device 52, or may store such data into the auxiliary storage device via the volatile storage device.

Hereinafter, with reference to the drawings, effectiveness of the pulsation suppression control will be confirmed using actual operation waveforms.

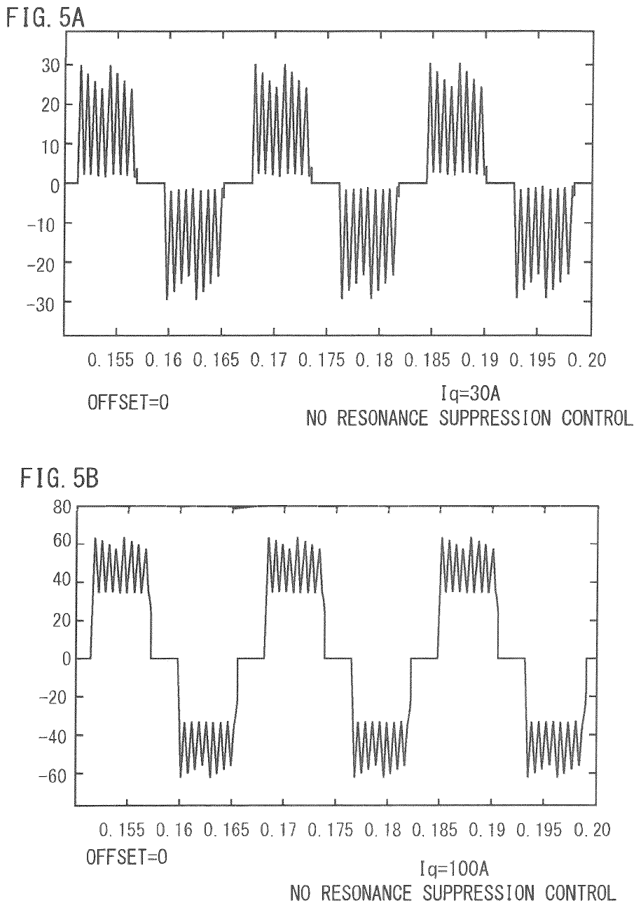

FIG. 5 shows operation waveforms in a power conversion device of a comparative example in which the pulsation suppression control is not performed.

FIG. 5A shows a power supply current waveform in a case of operating at a low torque load with Id=0 A and Ig=30 A. FIG. 5B shows a power supply current waveform in a case of operating at a high torque load with Id=0 A and Iq =100 A.

In both cases, great pulsations are occurring and thus it can be confirmed that resonance is occurring.

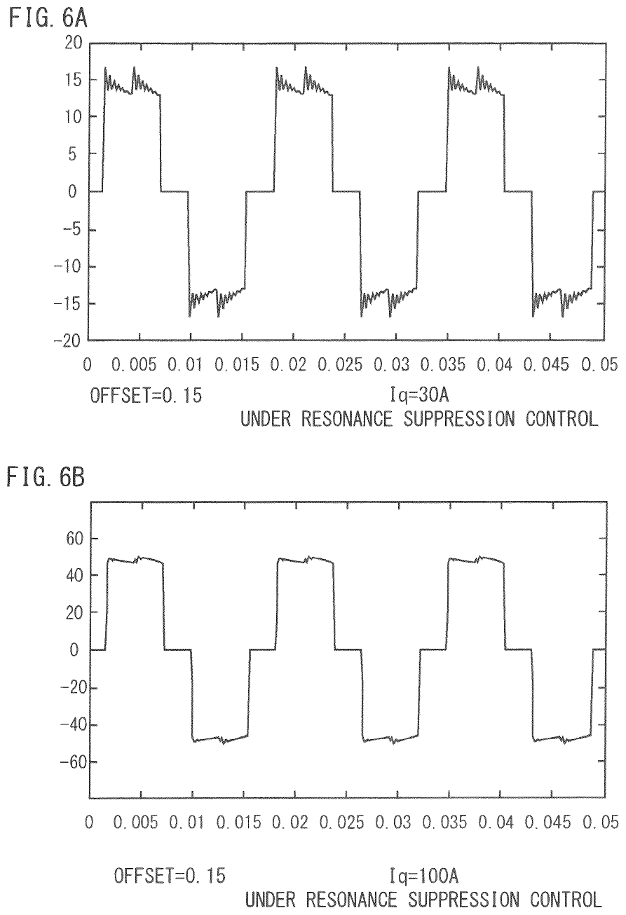

FIG. 6 shows operation waveforms in the power conversion device 100 of the present embodiment in which the pulsation suppression control is performed.

FIG. 6A shows a power supply current waveform in a case of operating at a low torque load with Id=0 A and Iq=30 A. FIG. 6B shows a power supply current waveform in a case of operating at a high torque load with Id=0 A and Iq =100 A.

As the feedback control in the pulsation suppression control unit 30, only P control is performed, and the Q-axis feedback gain is set as Kp=0.3. On D axis, since Id is 0 A, the effect of compensation is small, and therefore feedback is not performed in the case of these waveforms. That is. In the case of these waveforms, the power conversion device 100 corrects only one Q-axis voltage command Vq* by the Q-axis voltage correction command ΔVq*

With reference to both waveforms in FIG. 6A and FIG. 68, pulsation has successfully been reduced in both waveforms, and the effect of the pulsation suppression control can be confirmed.

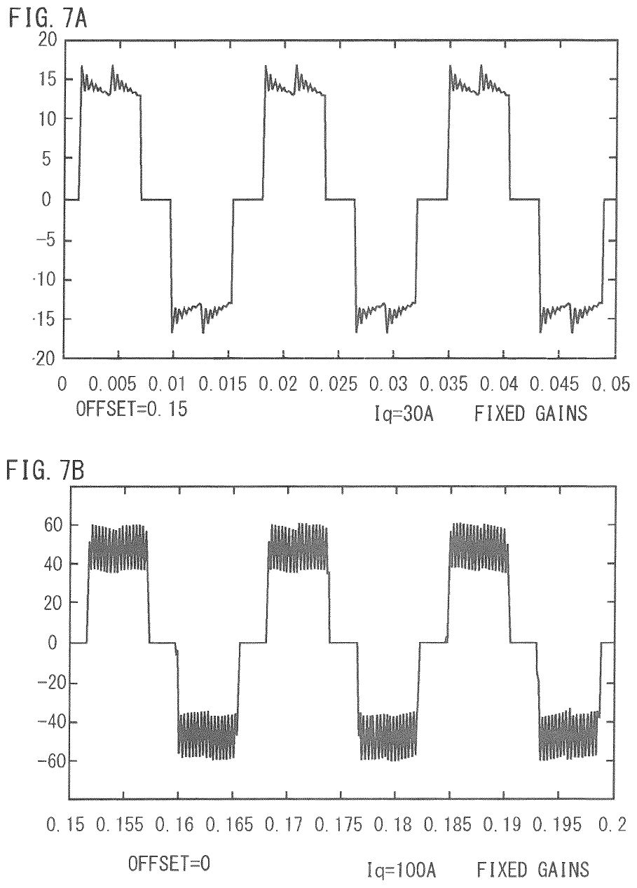

FIG. 7 shows operation waveforms in a case where the gains 37G, 38G are set at fixed values.

FIG. 7A shows a power supply current waveform in a case of operating at a low torque load with Id=0 A and Ig=30 A. Under this condition, the gains are adjusted so as to obtain the same waveform as in FIG. 6A. In this case, when operation is performed at a high torque load with Id=0 A and Iq=100 A, the waveform shown in FIG. 78 is produced, and it can be found that the power supply current waveform oscillates.

From the above, it can be confirmed that the gains 37G, 38G are important components for enabling stable operation in various operation conditions.

The gain 37G is configured to perform division by the D-axis current Id, and therefore the D-axis voltage correction command ΔVd* becomes extremely great when the value of the D-axis current Id is small. In this case, clamp control described below may be performed so that the value of the D-axis current Id does not become extremely small, or if the D-axis current Id is 0 or infinitely small, control of disabling the D-axis voltage correction command ΔVd* may be performed. The same applies to the Q-axis current Iq of the gain 38G.

In a case of performing clamp control, for example, when the D-axis current Id or the Q-axis current Ig has become a value within a set first value range, the value of the D-axis current Id used in the gain 37G or the value of the Q-axis current Iq used in the gain 38G may be adjusted to be a value above the first value range. For example, in a case where the first value range is set as −10 to +10, clamp control is performed such that, if the D-axis current Id is −2, the value thereof is clamped at −10.1, and if the Q-axis current Iq is +3, the value thereof is clamped at +10.1.

In particular, when the motor 7 is rotating at a low or middle speed, control is often performed with Id set at 0 A, and therefore the above situation applies.

The power conversion device of the present embodiment configured as described above includes:
a rectification unit which converts inputted three-phase AC voltages to DC voltage and outputs the DC voltage to a DC bus;
a power converter which converts the DC voltage on the DC bus converted by the rectification unit, to AC voltage, to control an electric motor; and
a control unit which controls the power converter, wherein
the control unit converts current flowing through the electric motor to D-axis current and Q-axis current in an orthogonal two-axis coordinate system, generates a D-axis voltage command so that the D-axis current follows a D-axis current command, generates a Q-axis voltage command so that the Q-axis current follows a Q-axis current command, and controls the power converter on the basis of the generated D-axis voltage command and the generated Q-axis voltage command,
the control unit derives, as a pulsation voltage prediction value, pulsation contained in the DC voltage obtained through full-wave rectification of the three-phase AC voltages, on the basis of a detected value of the three-phase AC voltages, and derives pulsation contained in the DC voltage, as a pulsation voltage actual measured value, on the basis of a detected value of the DC voltage, and
the control unit corrects at least one of the D-axis voltage command or the Q-axis voltage command by a voltage correction command generated so as to reduce a deviation between the pulsation voltage prediction value and the pulsation voltage actual measured value.

As described above, the control unit derives, as the pulsation voltage prediction value, pulsation contained in the DC voltage obtained through full-wave rectification of the three-phase AC voltages, on the basis of the detected value of the three-phase AC voltages. In addition, the control unit derives pulsation contained in the DC voltage of the DC bus as the pulsation voltage actual measured value, on the basis of the detected value of the DC voltage, and calculates the deviation between the pulsation voltage prediction value and the pulsation voltage actual measured value. The calculated deviation contains sixth-order harmonic pulsation components due to a crest value difference between the pulsation voltage prediction value and the pulsation voltage actual measured value, and also contains high-order pulsation for higher than sixth order due to rectification operation of the rectifier, resonance of the LC resonance circuit, and the like contained in the pulsation voltage actual measured value. The control unit generates the voltage correction command so that the calculated deviation is reduced, and corrects at least one of the D-axis voltage command or the Q-axis voltage command. Thus, pulsation of the power supply current and pulsation on the DC bus containing high-order noise can be effectively suppressed, whereby the inverter can be continuously operated stably and soundly.

In particular, on the basis of the deviation between the pulsation voltage prediction value and the pulsation voltage actual measured value, the voltage correction command is generated so as to reduce the deviation. Therefore, irrespective of the impedance on the power supply side, pulsation can be effectively suppressed, and the controlled variable therefor can be made small, so that the target value is readily followed, Thus, it becomes possible to effectively suppress also high-order noise for higher than sixth order.

The configuration is made such that the voltage commands for D axis and Q axis are corrected, instead of correcting current commands. Therefore, even in a case where a current control system is not designed to have high response, pulsation can be effectively suppressed. Thus, high-order noise can be effectively reduced.

In the power conversion device of the present embodiment configured as described above, the control unit subtracts, for every phase, smallest phase voltage from greatest phase voltage among the three-phase AC voltages at each phase, to derive the pulsation voltage prediction value.

As described above, a prediction value of pulsation contained in the DC voltage obtained through full-wave rectification is derived from phase voltages of the three-phase AC voltages. Thus, it is possible to accurately derive a prediction value of pulsation having a frequency that is six times the power supply frequency, from which pulsation due to rectification operation of the rectifier which occurs in the actual circuit, pulsation due to LC resonance of the IC circuit formed in the actual circuit, and the like are excluded.

In the power conversion device of the present embodiment configured as described above,
the control unit performs feedback control using a set control gain so that the deviation is reduced, to derive a controlled variable, and multiplies the controlled variable by a first gain configured to be proportional to the voltage of the DC bus, to generate the voltage correction command.

By performing the feedback control as described above, control response to a target value can be enhanced and thus high-order noise can be effectively suppressed.

In addition, by using the first gain configured to be proportional to the voltage of the DC bus, the D-axis voltage command and the Q-axis voltage command can be corrected with an appropriate controlled variable. Therefore, such a situation that correction is performed excessively of correction is insufficient can be avoided. Thus, it becomes possible to continuously operate the power converter stably and soundly. In addition, pulsation having a small amplitude in a case where the resonant frequency does not coincide with six times the power supply frequency can be suppressed accurately.

In the power conversion device of the present embodiment configured as described above,
the control unit generates the voltage correction command for correcting the D-axis voltage command, by multiplying the controlled variable by the first gain configured to be inversely proportional to the D-axis current, and
the control unit generates the voltage correction command for correcting the Q-axis voltage command, by multiplying the controlled variable by the first gain configured to be inversely proportional to the Q-axis current.

By using the first gain configured as described above, the D-axis voltage command and the Q-axis voltage command can be corrected with a more appropriate controlled variable, whereby the controlled variable of Aldo is made constant and the effect of control can be kept constant. Thus, pulsation occurring in the power supply current and the DC link section is stably eliminated, whereby it becomes possible to continuously operate the power converter stably and soundly.

In the power conversion device of the present embodiment configured as described above,
a value of at least one of the voltage of the DC bus, the D-axis current, or the Q-axis current composing the first gain is updated in accordance with a detected value thereof during operation of the power converter.

Thus, in various operation conditions such as a load current varying condition, deficiency of the controlled variable and variations in the control effect are suppressed, whereby pulsation can be efficiently suppressed.

In the power conversion device of the present embodiment configured as described above,
when the D-axis current or the Q-axis current becomes a value within a set first value range, the control unit performs clamp control for making adjustment so that a value of the D-axis current or the Q-axis current to be used in the first gain becomes a value above the first value range.

Thus, in various operation conditions, application of an excessive controlled variable and the like is prevented, whereby it becomes possible to continuously operate the power converter more stably and soundly.

### EMBODIMENT 2

Hereinafter, embodiment 2 of the present disclosure will be described focusing on a difference from the above embodiment 1, with reference to the drawings. The same parts as those in the above embodiment 1 are denoted by the same reference characters and the description thereof is omitted.

A circuit configuration of the power conversion device of the present embodiment 2 is the same as that shown in FIG. 1 in embodiment 1, A configuration of the control unit 50 of the present embodiment is also the same as that shown in FIG. 2 in embodiment 1, but an internal configuration of the pulsation suppression control unit 30 is different.

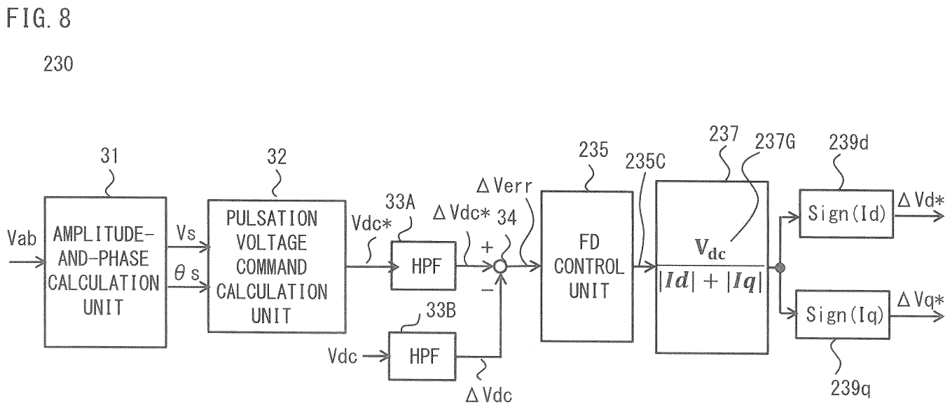

FIG. 8 is a control block diagram showing an internal configuration of a pulsation suppression control unit 230 of the power conversion device according to embodiment 2,

The pulsation suppression control unit 230 of the present embodiment 2 is different from the pulsation suppression control unit 30 of embodiment 1 in that a feedback control unit 235, a gain adjustment unit 237, and positive/negative determination units 239d, 239q as sign functions are provided.

In particular, unlike embodiment 1, the feedback control unit 235 for suppressing resonance is characterized by having the same configuration between D axis and Q axis, and derives a controlled variable 235C to be used in common for generating the D-axis voltage correction command ΔVd* and the Q-axis voltage correction command ΔVq* for respectively correcting the D-axis voltage command Vd* and the Q-axis voltage command Vq*.

As the feedback control in the feedback control unit 235, normally, proportional (P) control is used. In a case where a control band is raised, proportional differential (PD) control may be used. Instead of PD control, control using a phase-lead compensation filter for advancing a phase of the controlled variable by a set phase amount and proportional (P) control may be performed in combination.

Then, with respect to the controlled variable 2350 used in common between D axis and Q axis as described above, the gain adjustment unit 237 multiplies the controlled variable 235C by a gain 237G (Vdc/(ID|+|Iq|)) as a first gain used in common between D axis and Q axis.

The gain 237G is configured to be proportional to the DC bus voltage Vdc and inversely proportional to the sum of the absolute value of D-axis current Id and the absolute value of Q-axis current Iq.

Next, on D axis, with respect to the controlled variable multiplied by the gain 2376, the positive/negative determination unit 239d multiplies the controlled variable by a sign function Sign (Id) which takes only the polarity of the D-axis current Id which is a variable, to generate the voltage correction command ΔVd* Next, on ω axis, with respect to the controlled variable multiplied by the gain 237G, the positive/negative determination unit 239q multiplies the controlled variable by a sign function Sign (Iq) which takes only the polarity of the Q-axis current Iq which is a variable, to generate the voltage correction command ΔVq*.

The D-axis voltage command Vd* and the Q-axis voltage command Vq* are corrected by the D-axis voltage correction command ΔVd* and the Q-axis voltage correction command ΔVq* generated as described above.

Hereinafter, the configurations of the gain 237G and the positive/negative determination units 239d, 239q in the present embodiment will be described.

In embodiment 1, it has been confirmed that ΔIde is derived by the above Formula (19),

Here, in the present embodiment, ΔVd to be given to the voltage command in order to suppress pulsation, i.e., the D-axis voltage correction command ΔVd*, is represented by the following Formula (20). In addition, ΔVq to be intentionally given to the voltage command in order to suppress pulsation, i.e., the Q-axis voltage correction command ΔVq*, is represented by the following Formula (21).

$$\begin{matrix}[ Mathematical 20 ] & \\ Δ {V}_{d}^{*} = {V}_{dc} \cdot sign ( {I}_{d} ) / ( \vert {I}_{d} \vert + \vert {I}_{q} \vert ) \cdot {K}_{p} Δ {V}_{err} & ( 20 )\end{matrix}$$

$$\begin{matrix}[ Mathematical 21 ] & \\ Δ {V}_{q}^{*} = {V}_{dc} \cdot sign ( {I}_{d} ) / ( \vert {I}_{d} \vert + \vert {I}_{q} \vert ) \cdot {K}_{p} Δ {V}_{err} & ( 21 )\end{matrix}$$

Here, ΔVerr is a deviation between the pulsation voltage prediction value ΔVdc* and the pulsation voltage actual measured value ΔVdc, and corresponds to an output of the subtractor 34. In addition, as the feedback control performed for deriving Δvd*, ΔVq*, only proportional (P) control using the proportional gain Kp is performed.

Then, the D-axis current Id is 0 or a negative value, and Ig is a positive value in a normal state. Therefore, the above Formulae (20) and (21) can be rewritten as shown by the following Formulae (22) and (23),

$$\begin{matrix}[ Mathematical 22 ] & \\ Δ {V}_{d}^{*} = - {V}_{dc} / ( - {I}_{d} + {I}_{q} ) \cdot {K}_{p} Δ {V}_{err} & ( 22 )\end{matrix}$$

$$\begin{matrix}[ Mathematical 23 ] & \\ Δ {V}_{q}^{*} = {V}_{dc} / ( - {I}_{d} + {I}_{q} ) \cdot {K}_{p} Δ {V}_{err} & ( 23 )\end{matrix}$$

By substituting Formulas (22) and (23) into Formula (19), Formula (24) is obtained.

$$\begin{matrix}[ Mathematical 24 ] & \\ \begin{matrix}Δ {I}_{dc} = {I}_{d} / {V}_{dc} \cdot \{ - {V}_{dc} / ( - {I}_{d} + {I}_{q} ) \cdot {K}_{p} Δ {V}_{err} \} + \\ {I}_{q} / {V}_{dc} \cdot \{ {V}_{dc} / ( - {I}_{d} + {I}_{q} ) \cdot {K}_{p} Δ {V}_{err} \} \\ = {K}_{p} Δ {V}_{err}\end{matrix} & ( 24 )\end{matrix}$$

That is, the characteristics of output power of the Inverter 6 shown by the above Formula (19) can be made into simple characteristics in which the influence of physical parameters Vdc, Id, id is canceled out, as shown by the above Formula (24).

Through such adjustment, the controlled variable of ΔIdc can be made constant, and deficiency of the controlled variable, occurrence of pulsation, and variations in the control effect depending on the condition can be suppressed, and resonance can be efficiently suppressed.

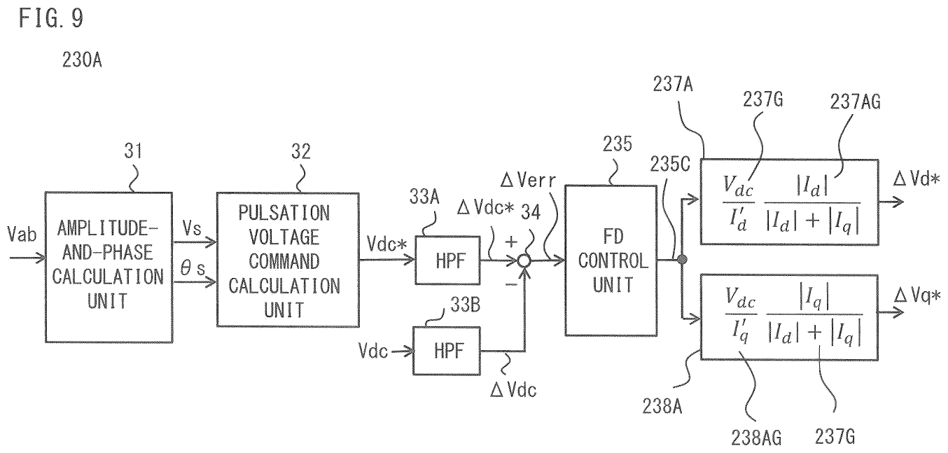

Next, another gain calculation method will be described. The internal configuration of the pulsation suppression control unit may be replaced with that of a pulsation suppression control unit 230A shown in FIG. 9.

FIG. 9 is a control block diagram showing an internal configuration of the pulsation suppression control unit 230A of the power conversion device according to embodiment 2.

A difference from the pulsation suppression control unit 230 shown in FIG. 8 is that the controlled variable 235C is multiplied by gains in the gain adjustment units 237A, 238A.

On D axis, the gain adjustment unit 237A multiplies the controlled variable 235C by the gain 237G (Vdc/(|Id|+|Iq|)) as a first gain and in addition, a gain 237AG (|Id|/Id′) as a second gain.

On Q axis, the gain adjustment unit 238A multiplies the controlled variable 235C by the gain 237G (Vac/(|Id|+|Iq|)) as a first gain and in addition, a gain 238AG (|Iq|/Iq′) as a second gain.

The gain 237AG is configured to be proportional to the absolute value of D-axis current Id and inversely proportional to the value of the D-axis current Id clamp-controlled to be a value above the set first value range.

The gain 238AG is configured to be proportional to the absolute value of Q-axis current Iq and inversely proportional to the value of Q-axis current Iq clamp-controlled to be a value above the set first value range.

The denominator Id′ of the gain 237AG is the D-axis current Id that has undergone limiter processing by clamp control, and the denominator Iq′ of the gain 238AG is the Q-axis current Ig that has undergone limiter processing by clamp control.

The limiter processing by the clamp control is to clamp the output so that the absolute value of each of the D-axis current Id and the Q-axis current Iq does not become a value within the set first value range. For example, in a case where the first value range is set as −9 A to 9 A, when 7 A is inputted, the output is clamped at 9.1 A. Conversely, when −7 A is inputted, the output is clamped at −9.1 A.

Thus, even if the absolute values of D-axis current Id and Q-axis current Ig are small, the voltage commands are not excessively corrected.

With this block, for example, in a case of Id=0 A, when clamp control is performed, the voltage correction command ΔVd* becomes 0 V. Conversely, in a case of not performing clamp control on both of D axis and Q axis, operation is the same as in the pulsation suppression control having the configuration shown in FIG. 8.

In the power conversion device of the present embodiment configured as described above, the control unit generates the voltage correction commands for correcting the D-axis voltage command and the Q-axis voltage command, by multiplying the controlled variable by the first gain configured to be inversely proportional to a sum of an absolute value of the D-axis current and an absolute value of the Q-axis current.

In the power conversion device of the present embodiment configured as described above,

In the feedback control, the control unit derives the controlled variable to be used in common for generating the voltage correction commands for correcting the D-axis voltage command and the Q-axis voltage command.

By using the first gain configured as described above, the D-axis voltage command and the Q-axis voltage command can be corrected with an appropriate controlled variable, and also, feedback control can be implemented with one configuration for both of D axis and Q axis. Thus, feedback control executed in the control unit can be reduced, the same first gain can be used for D axis and Q axis, and the controlled variable that can be used in common for generating the voltage correction commands for correcting D-axis and Q-axis voltage commands is derived. Therefore, the control configuration can be simplified, and the control load on the control unit can be reduced. Thus, high-speed response is achieved in feedback control and high-order pulsation can be effectively suppressed.

In the power conversion device of the present embodiment configured as described above, in the configuration in which the first gain is inversely proportional to the sum of the absolute value of the D-axis current and the absolute value of the Q-axis current,

with respect to the controlled variable to be used in common for correcting the D-axis voltage command and the Q-axis voltage command, the control unit multiplies the controlled variable by a sign function that takes only a polarity of the D-axis current which is a variable, to generate the voltage correction command for correcting the D-axis voltage command, and multiplies the controlled variable by the sign function that takes only a polarity of the Q-axis current which is a variable, to generate the voltage correction command for correcting the Q-axis voltage command.

As described above, with respect to the same controlled variable to be used in common for D axis and Q axis, the voltage correction commands are generated by multiplying the controlled variable by the sign functions that take only the polarities of the D-axis and Q-axis currents, whereby the output of the power converter can be controlled with simple characteristics in which the deviation ΔVerr is multiplied by the gain Kp. Thus, in various operation conditions, it becomes possible to continuously operate the power converter stably and soundly.

In the power conversion device of the present embodiment configured as described above,

in the configuration in which the first gain is inversely proportional to the sum of the absolute value of the D-axis current and the absolute value of the Q-axis current,

the control unit multiplies the controlled variable to be used in common for correcting the D-axis voltage command and the Q-axis voltage command, by a second gain in addition to the first gain, and

the second gain is
configured to be proportional to the absolute value of the D-axis current and inversely proportional to a value of the D-axis current clamp-controlled to be a value above a set first value range, or
configured to be proportional to the absolute value of the Q-axis current and inversely proportional to a value of the Q-axis current clamp-controlled to be a valve above a set first value range.

Thus, even in a case where the driving condition of the electric motor is changed, excessive correction is prevented, pulsation is suppressed, and the inverter can be 5 continuously operated stably and soundly.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment,

### DESCRIPTION OF THE REFERENCE CHARACTERS

2 rectifier (rectification unit)
6 inverter (power converter)
7 motor (electric motor)
50 control unit
37G, 38G gain (first gain)
100 power conversion device
P, N, DC bus

1. A power conversion device comprising:
a rectifier which converts inputted three-phase AC voltages to DC voltage and outputs the DC voltage to a DC bus:
a power converter which converts the DC voltage on the DC bus converted by the rectification unit rectifier, to AC voltage, to control an electric motor; and
a controlling circuitry which controls the power converter, wherein the controlling circuitry converts current flowing through the electric motor to D-axis current and Q-axis current in an orthogonal two-axis coordinate system, generates a D-axis voltage command so that the D-axis current follows a D-axis current command, generates a Q-axis voltage command so that the Q-axis current follows a Q-axis current command, and controls the power converter on the basis of the generated D-axis voltage command and the generated Q-axis voltage command,
the controlling circuitry derives, as a pulsation voltage prediction value, pulsation contained in the DC voltage obtained through full-wave rectification of the three-phase AC voltages, on the basis of a detected value of the three-phase AC voltages, and derives pulsation contained in the DC voltage, as a pulsation voltage actual measured value, on the basis of a detected value of the DC voltage, and
the controlling circuitry corrects at least one of the D-axis voltage command or the Q-axis voltage command by a voltage correction command generated so as to reduce a deviation between the pulsation voltage prediction value and the pulsation voltage actual measured value.

2. The power conversion device according to claim 1, wherein
the controlling circuitry subtracts, for every phase, smallest phase voltage from greatest phase voltage among the three-phase AC voltages at each phase, to derive the pulsation voltage prediction value.

3. The power conversion device according to claim 1, wherein
the controlling circuitry performs feedback control using a set control gain so that the deviation is reduced, to derive a controlled variable, and multiplies the controlled variable by a first gain configured to be proportional to the voltage of the DC bus, to generate the voltage correction command.

4. The power conversion device according to claim 3, wherein
the controlling circuitry generates the voltage correction command for correcting the D-axis voltage command, by multiplying the controlled variable by the first gain configured to be inversely proportional to the D-axis current, and
the controlling circuitry generates the voltage correction command for correcting the Q-axis voltage command, by multiplying the controlled variable by the first gain configured to be inversely proportional to the Q-axis current.

5. The power conversion device according to claim 3, wherein
the controlling circuitry generates the voltage correction commands for correcting the D-axis voltage command and the Q-axis voltage command, by multiplying the controlled variable by the first gain configured to be inversely proportional to a sum of an absolute value of the D-axis current and an absolute value of the Q-axis current.

6. The power conversion device according to claim 5, wherein
in the feedback control, the controlling circuitry derives the controlled variable to be used in common for generating the voltage correction commands for correcting the D-axis voltage command and the Q-axis voltage command.

7. The power conversion device according to claim 6, wherein
in the configuration in which the first gain is inversely proportional to the sum of the absolute value of the D-axis current and the absolute value of the Q-axis current,
with respect to the controlled variable to be used in common for correcting the D-axis voltage command and the Q-axis voltage command, the controlling circuitry multiplies the controlled variable by a sign function that takes only a polarity of the D-axis current which is a variable, to generate the voltage correction command for correcting the D-axis voltage command, and multiplies the controlled variable by the sign function that takes only a polarity of the Q-axis current which is a variable, to generate the voltage correction command for correcting the Q-axis voltage command.

8. The power conversion device according to claim 5, wherein
in the configuration in which the first gain is inversely proportional to the sum of the absolute value of the D-axis current and the absolute value of the Q-axis current,
the controlling circuitry multiplies the controlled variable to be used in common for correcting the D-axis voltage command and the Q-axis voltage command, by a second gain in addition to the first gain, and
the second gain is
configured to be proportional to the absolute value of the D-axis current and inversely proportional to a value of the D-axis current clamp-controlled to be a value above a set first value range, or
configured to be proportional to the absolute value of the Q-axis current and inversely proportional to a value of the Q-axis current clamp-controlled to be a value above a set first value range.

9. The power conversion device according to claim 3, wherein
in the feedback control, one of proportional control, proportional differential control, or control in which control for advancing a phase of the controlled variable by a set phase amount and proportional control are performed in combination, is performed.

10. The power conversion device according to claim 4, wherein
when the D-axis current or the Q-axis current becomes a value within a set first value range, the controlling circuitry performs clamp control for making adjustment so that a value of the D-axis current or the Q-axis current to be used in the first gain becomes a value above the first value range.

11. The power conversion device according to claim 3, wherein
a value of at least one of the voltage of the DC bus, the D-axis current, or the Q-axis current composing the first gain is updated in accordance with a detected value thereof during operation of the power converter.

12. The power conversion device according to claim 2, wherein
the controlling circuitry performs feedback control using a set control gain so that the deviation is reduced, to derive a controlled variable, and multiplies the controlled variable by a first gain configured to be proportional to the voltage of the DC bus, to generate the voltage correction command.

13. The power conversion device according to claim 12, wherein
the controlling circuitry generates the voltage correction command for correcting the D-axis voltage command, by multiplying the controlled variable by the first gain configured to be inversely proportional to the D-axis current, and
the controlling circuitry generates the voltage correction command for correcting the Q-axis voltage command, by multiplying the controlled variable by the first gain configured to be inversely proportional to the Q-axis current.

14. The power conversion device according to claim 12, wherein
the controlling circuitry generates the voltage correction commands for correcting the D-axis voltage command and the Q-axis voltage command, by multiplying the controlled variable by the first gain configured to be inversely proportional to a sum of an absolute value of the D-axis current and an absolute value of the Q-axis current.

15. The power conversion device according to claim 14, wherein
in the feedback control, the controlling circuitry derives the controlled variable to be used in common for generating the voltage correction commands for correcting the D-axis voltage command and the Q-axis voltage command.

16. The power conversion device according to claim 15, wherein
in the configuration in which the first gain is inversely proportional to the sum of the absolute value of the D-axis current and the absolute value of the Q-axis current,
with respect to the controlled variable to be used in common for correcting the D-axis voltage command and the Q-axis voltage command, the controlling circuitry multiplies the controlled variable by a sign function that takes only a polarity of the D-axis current which is a variable, to generate the voltage correction command for correcting the D-axis voltage command, and multiplies the controlled variable by the sign function that takes only a polarity of the Q-axis current which is a variable, to generate the voltage correction command for correcting the Q-axis voltage command.

17. The power conversion device according to claim 6, wherein
in the configuration in which the first gain is inversely proportional to the sum of the absolute value of the D-axis current and the absolute value of the Q-axis current,
the controlling circuitry multiplies the controlled variable to be used in common for correcting the D-axis voltage command and the Q-axis voltage command, by a second gain in addition to the first gain, and
the second gain is
configured to be proportional to the absolute value of the D-axis current and inversely proportional to a value of the D-axis current clamp-controlled to be a value above a set first value range, or
configured to be proportional to the absolute value of the Q-axis current and inversely proportional to a value of the Q-axis current clamp-controlled to be a value above a set first value range.

18. The power conversion device according to claim 15, wherein
in the configuration in which the first gain is inversely proportional to the sum of the absolute value of the D-axis current and the absolute value of the Q-axis current,
the controlling circuitry multiplies the controlled variable to be used in common for correcting the D-axis voltage command and the Q-axis voltage command, by a second gain in addition to the first gain, and
the second gain is
configured to be proportional to the absolute value of the D-axis current and inversely proportional to a value of the D-axis current clamp-controlled to be a value above a set first value range, or
configured to be proportional to the absolute value of the Q-axis current and inversely proportional to a value of the Q-axis current clamp-controlled to be a value above a set first value range.

19. The power conversion device according to claim 4, wherein
in the feedback control, one of proportional control, proportional differential control, or control in which control for advancing a phase of the controlled variable by a set phase amount and proportional control are performed in combination, is performed.

20. The power conversion device according to claim 5, wherein
in the feedback control, one of proportional control, proportional differential control, or control in which control for advancing a phase of the controlled variable by a set phase amount and proportional control are performed in combination, is performed.
